(19) United States
(12) Patent Application Publication
(10) Pub. No.: US 2017/0191613 A1
(43) Pub. Date: Jul. 6, 2017

(54) PLATFORM

(71) Applicant: ZEROTECH (Chongqing) Intelligence Technology Co., Ltd., Chongqing (CN)

(72) Inventors: Geng-Peng Liu, Beijing (CN); Jie Tang, Beijing (CN)

(73) Assignee: ZEROTECH (Chongqing) Intelligence Technology Co., Ltd., Chongqing (CN)

(21) Appl. No.: 15/395,488

(22) Filed: Dec. 30, 2016

(30) Foreign Application Priority Data
Jan. 5, 2016 (CN) 201610007033.8

(51) Int. Cl. F16M 13/02; H02K 11/30; H02K 5/04; H02K 11/215; F16M 11/12; F16M 11/18

(52) U.S. Cl. CPC F16M 13/022; F16M 11/12; F16M 11/18; H02K 5/04; H02K 11/215; H02K 11/30; B60R 11/04

(57) ABSTRACT

A platform includes a yaw arm, a roll arm, and a pitch arm, and further includes a first, second, and third electric motors configured to drive the arms. The first, second, and third electric motors each include a first stator and a first rotor. The first stator or the first rotor is directly secured to one arm.

### CROSS-REFERENCE TO RELATED APPLICATIONS

This application claims all benefits accruing under 35 U.S.C. §119 from Chinese Patent Application No. 201610007033.8, filed on Jan. 5, 2016 in the State Intellectual Property Office of China, the content of which is hereby incorporated by reference.

### FIELD

The present disclosure relates to platforms for carrying payloads.

### BACKGROUND

A vehicle may carry a payload through a platform to perform a task, such as aerial photography, surveillance, resource exploration, geological survey, and remote sensing. For example, an unmanned aerial vehicle may be equipped with a gimbal for carrying a camera. The platform can comprise an electric motor and an arm driven by the electric motor to rotate the payload about an axis, such as a pitch axis, a roll axis, or a yaw axis, to adjust an orientation of the payload (e.g., to adjust a shooting angle of a camera). The electric motor can comprise a rotor which is a moving part, a stator which is a stationary part, and an output shaft which is joined to the rotor and outputs a rotating force. The output shaft is a cantilever in the platform and secured to the arm.

### BRIEF DESCRIPTION OF THE DRAWINGS

Implementations are described by way of example only with reference to the attached figures.

FIG. 1 is a schematic view of one embodiment of a platform.

FIG. 2 is a schematic view of one embodiment of a support member and an electric motor.

FIG. 3 is a schematic view of one embodiment of a first support member and a first electric motor connected to the first support member.

FIG. 4 is a schematic view of one embodiment of a second support member and a second electric motor connected to the second support member.

FIG. 5 is a schematic view of one embodiment of a third support member and a third electric motor connected to the third support member.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

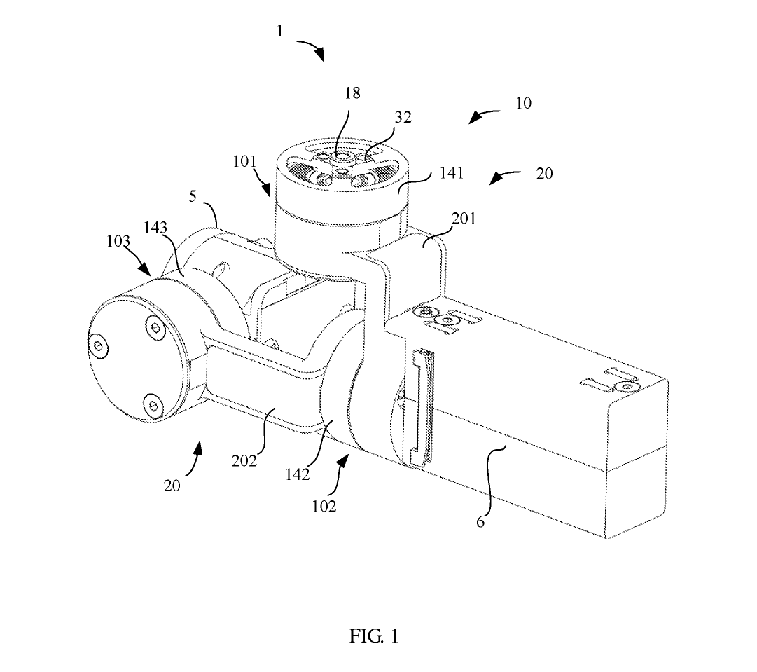

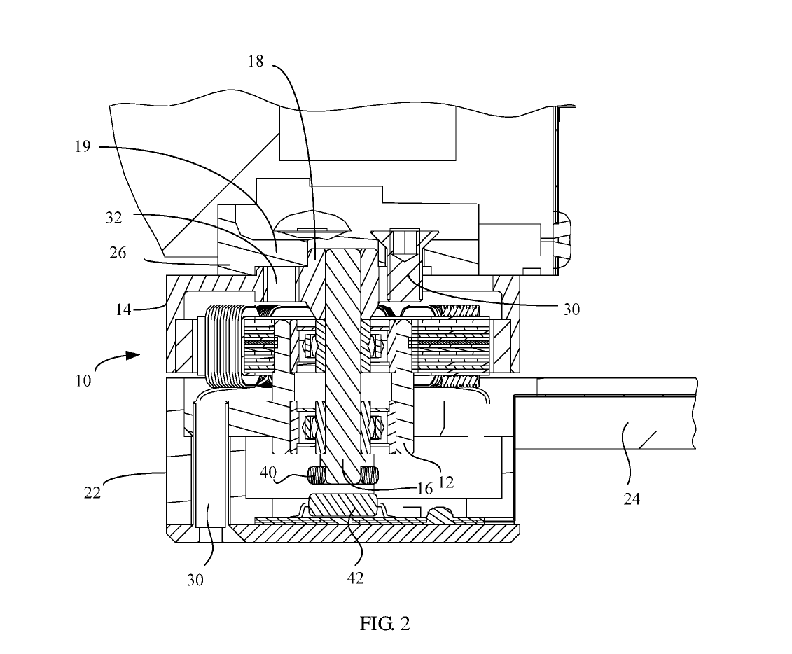

Referring to FIG. 1 and FIG. 2, one embodiment of a platform 1 comprises at least one support member 20 and at least one electric motor 10. The platform 1, which can be a gimbal, is configured to carry and rotate a payload 5. The support member 20, which can be a support arm, is configured to directly or indirectly couple with and support the payload 5. The electric motor 10 is configured to drive the support member 20 thereby rotating the support member 20 about or around at least one axis. The support member 20 driven by the electric motor 10 rotates about or around the at least one axis, and the payload 5 coupled to the support member 20 rotates with the support member 20.

Each electric motor 10 comprises a stator 12, a rotor 14 configured to rotate relative to the stator 12, and an electromagnetic member, such as an electromagnetic coil. One of the stator 12 and the rotor 14 is directly secured to the corresponding support member 20. The electric motor 10 may comprise a rotor shaft 16 fixed to the rotor 14. However, the rotor shaft 16 is not secured to the support member 20. Securing the support member 20 to one of the stator 12 and the rotor 14 can avoid using a cantilever such as the rotor shaft 16 to output the rotation, thereby enhancing the strength and reliability between the electric motor 10 and the support member 20 and decreasing a weight and size of the platform 1. The rotor shaft 16 can have a smaller size and weight. The rotor shaft 16 can be received in the rotor 14 and rotate with the rotor 14 relative to the stator 12 about a longitudinal axis of the rotor shaft 16.

The stator 12 or the rotor 14 can be fixed to the corresponding support member 20 through a fastening member 30, such as a screw, a bolt, a latch, a nut, a nail, or a pin. A hole 32 can be defined on the stator 12 or the rotor 14 to receive the fastening member 30 thereby fixing the stator 12 or the rotor 14 to the corresponding support member 20. The stator 12 or the rotor 14 can be disassembled from the corresponding support member 20 by releasing the fastening member 30. In one embodiment, the fastening member 30 is a screw, and a screw hole 32 is defined on the stator 12 or the rotor 14.

The electric motor 10 can further comprise a first locating member 18. In one embodiment, the first locating member 18 is located on the end of the rotor shaft 16 closed to the rotor 14. In another embodiment, the first locating member 18 is located on an end of the stator 12 or the rotor 14 along the rotating axis. The first locating member 18 and the stator 12 or the rotor 14 can be integrated as one piece.

The corresponding support member 20 can further comprise a second locating member 19. The first locating member 18 and the second locating member 19 are configured to engage with each other thereby assisting the user to assemble the electric motor 10 with the support member 20 quickly and easily. By engaging the first locating member 18 with the second locating member 19, the stator 12 or the rotor 14 and the support member 20 are at a location allowing the fastening member 30 to secure the stator 12 or the rotor 14 to the support member 20. For example, by engaging the first locating member 18 with the second locating member 19, the holes 32 defined on the stator 12 or the rotor 14 and the support member 20 are in alignment with each other allowing the screw 30 to run through the holes 32.

In one embodiment, the first locating member 18 can be a protrusion, and the second locating member 19 can be a recession corresponding to the protrusion. In another embodiment, the first locating member 18 can be a recession, and the second locating member 19 can be a protrusion corresponding to the recession.

The support member 20 can comprise a casing member 22 and a support body 24. In one embodiment, the support member 20 comprises two casing members 22. In another embodiment, the support member 20 comprises one casing member 22 and one securing member 26. The casing member 22 and the securing member 26 can be mounted on the support body 24. In one embodiment, the casing member 22 and the securing member 26 can be respectively located at two opposite ends of the support body 24. The casing member 22 is configured to enclose a portion of one electric motor 10, such as the stator 12. The securing member 26 is configured to secure directly with one of the stator 12 and the rotor 14. The casing member 22, the support body 24, and the securing member 26 can be integrated as one piece.

The platform 1 can further comprise a magnet 40 and a magnetic encoder 42 such as a rotary encoder. The magnet 40 and the magnetic encoder 42 are spaced from each other and facing each other. The magnetic encoder 42 is configured to receive a signal from the magnet 40 to sense a rotational degree of the rotor 14 relative to the stator 12. The magnet 42 can be mounted on an end of the rotor shaft 16. The magnetic encoder 42 can be mounted on a support member 20 that is secured to the stator 12 of the electric motor 10. The magnetic encoder 42 is electrically connected to a platform controller 6 through signal wires. The platform controller 6 can be mounted on a support member 20, such as the yaw arm 201.

The platform 1 can comprise more than one support member 20 and more than one electric motor 10 driving the support member 20 in a one-to-one manner. The plurality of support members 20 can be connected one by one to rotate the payload 5 about or around a plurality of axes. In some embodiments, the platform 1 can further comprise more than one fastening member 30 for respectively securing the support members 20 to the stators 12 or the rotors 14. The platform 1 can further comprise more than one magnet 40 and more than one encoder 42 respectively located on the electric motors 10 and the support members 20.

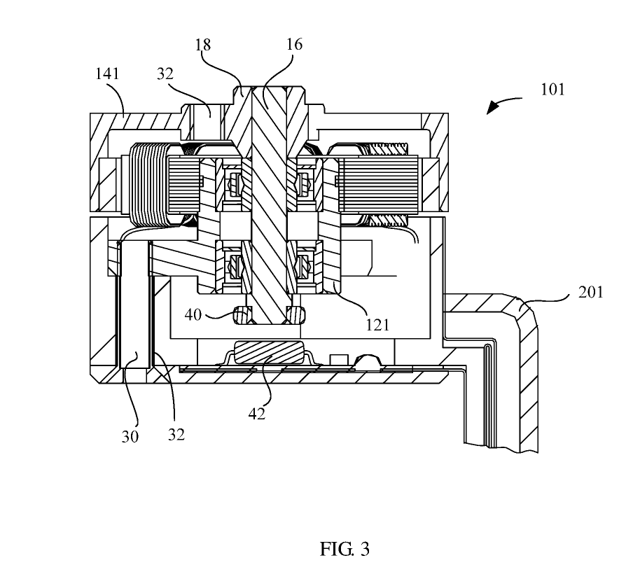

Referring to FIG. 3, in one embodiment, the platform 1 comprises a first electric motor 101 and a first support member 201 driven by the first electric motor 101. The first electric motor 101 is configured to rotate the first support member 201 thereby outputting a rotation to rotate the payload 5 about or around a first rotating axis, such as a yaw axis. The first support member 201 can be a yaw arm. The first electric motor 101 comprises a first stator 121 and a first rotor 141. The first stator 121 can be directly secured to the first support member 201. The first rotor 141 can be secured to a mounting member (not shown) of the platform 1.

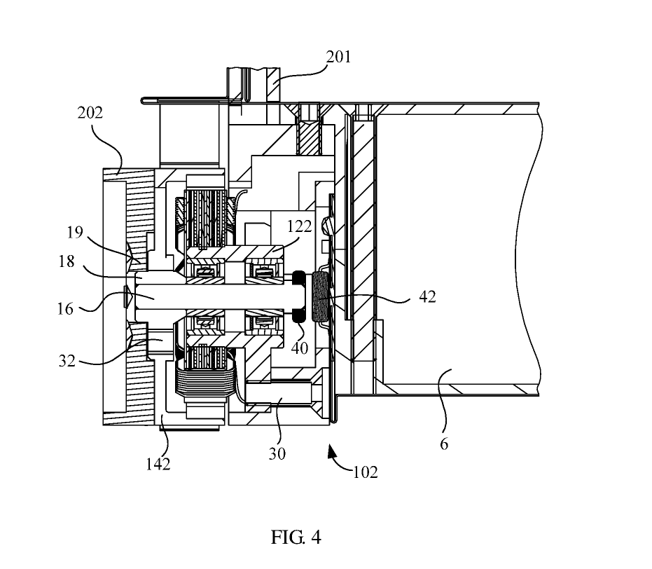

Referring to FIG. 4, in another embodiment, the platform 1 can further comprise a second electric motor 102 and a second support member 202 driven by the second electric motor 102. The second electric motor 102 is configured to rotate the second support member 202 thereby outputting a rotation to rotate the payload 5 about or around a second rotating axis, such as a roll axis. The second support member 202 can be a roll arm. The second electric motor 102 comprises a second stator 122 and a second rotor 142. The second stator 122 can be directly or indirectly secured to the first support member 201. The second rotor 142 can be directly secured to the second support member 202.

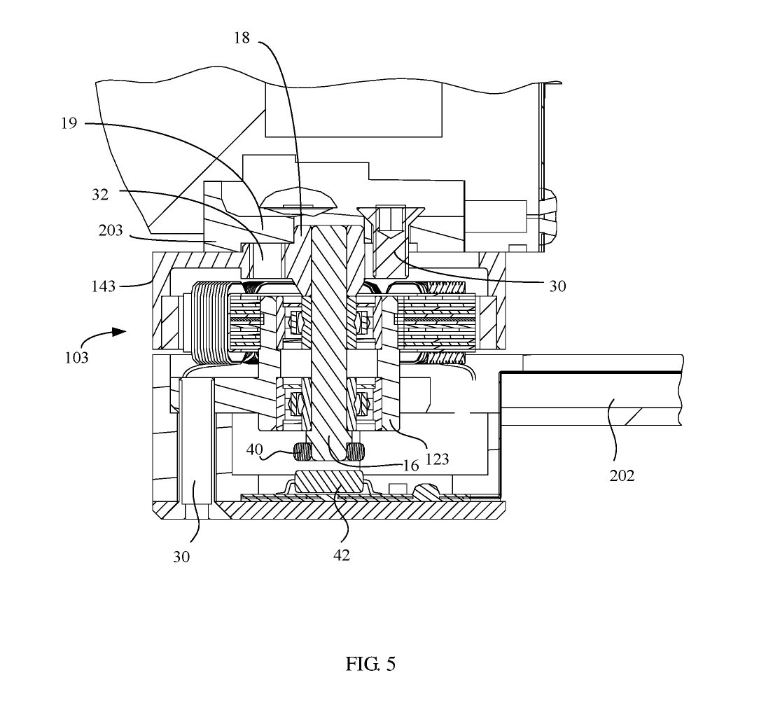

Referring to FIG. 5, in yet another embodiment, the platform 1 can further comprise a third electric motor 103 and a third support member 203 driven by the third electric motor 103. The third electric motor 103 is configured to rotate the third support member 203 thereby outputting a rotation to rotate the payload 5 about or around a third rotating axis, such as a pitch axis. The third support member 203 can be a pitch arm. The third electric motor 103 comprises a third stator 123 and a third rotor 143. The third stator 123 can be directly or indirectly secured to the second support member 202. The third rotor 143 can be directly secured to the third support member 203.

In the embodiment that the platform controller 14 is mounted on the first support member 20, the securing of the first stator 121 to the first support member 201 is to let the conducting wires, such as the signal wires and the motor wires, running through the first support member 20, which avoids an entanglement of wires. The same effect can be achieved by securing the second rotor 142 to the second support member 202, and by securing the third rotor 143 to the third support member 203.

The payload 5, such as a camera, carried by the platform 1, can rotate with the first, second, and third support members 201, 202, 203 about or around the yaw axis, the roll axis, and the pitch axis independently. Securing the first, second, and third support members 201, 202, 203 with one of the first, second, and third stators 121, 122, 123 and the first, second, and third rotor 141, 142, 143 can avoid using a cantilever such as a thick rotor shaft 16 to output the rotation, thereby enhancing the strength and reliability between the first, second, and second electric motors 101, 102, 103 and the first, second, and third support members 201, 202, 203 and decreasing a weight and size of the platform 1.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A platform comprising:
a first support member; and
a first electric motor configured to drive the first support member;
wherein the first electric motor comprises a first stator and a first rotor, and the first stator or the first rotor is directly secured to the first support member.

2. The platform of claim 1 further comprising a second support member and a second electric motor configured to drive the second support member.

3. The platform of claim 2, wherein the second electric motor comprises a second stator and a second rotor, and one of the second stator and the second rotor is directly secured to the second support member.

4. The platform of claim 2 further comprising a third support member, and a third electric motor configured to drive the third support member.

5. The platform of claim 4, wherein the third electric motor comprises a third stator and a third rotor, one of the third stator and the third rotor is directly secured to the third support member.

6. The platform of claim 4, wherein the first, second, and third support members are yaw, roll, pitch arms, respectively.

7. The platform of claim 1, wherein the first stator or the first rotor is directly secured to the first support member through a fastening member.

8. The platform of claim 7, wherein the fastening member is selected from the group consisting of a screw, a bolt, a latch, a nut, a nail, and a pin.

9. The platform of claim 7, wherein the fastening member is a screw, and a screw hole is defined on the stator or the rotor.

10. The platform of claim 1, wherein the first electric motor comprises a first locating member, and the first support member comprises a second locating member configured to engage with the first locating member.

11. The platform of claim 10, wherein the first locating member is a protrusion or a recession.

12. The platform of claim 1, wherein the first support member comprises a support body and a casing member mounted on the support body, the casing member is configured to enclose a portion of one electric motor.

13. The platform of claim 12, wherein the first support member further comprises a securing member, and the securing member is configured to secure directly with one of the first stator and the first rotor.

14. The platform of claim 12, wherein the first support member comprises two casing members mounted on the support body at two opposite ends of the support body.

15. The platform of claim 1 further comprises a rotor shaft, a magnet mounted on an end of the rotor shaft, and a magnetic encoder spaced from and faced to the magnet; the magnetic encoder is configured to be connected to a platform controller.

16. The platform of claim 3, wherein the second stator is coupled to the first support member, and the second rotor is directly secured to the second support member.

17. The platform of claim 5, wherein the third stator is coupled to the second support member, and the third rotor is directly secured to the third support member.

18. A platform comprising:
a plurality of support members connected one by one;
a plurality of electric motors driving the plurality of support members in a one-to-one manner, the plurality of electric motors each comprising a stator and a rotor,
wherein the stator or the rotor is directly secured to a corresponding support member.
